(19) United States
(12) Patent Application Publication
(10) Pub. No.: US 2020/0041748 A1
(43) Pub. Date: Feb. 6, 2020

(54) LENS MODULE

(71) Applicant: AAC Technologies Pte. Ltd., Singapore City (SG)

(72) Inventor: Jia Wan, Shenzhen (CN)

(21) Appl. No.: 16/525,595

(22) Filed: Jul. 30, 2019

(30) Foreign Application Priority Data
Aug. 3, 2018 (CN) 201821245236.1

(51) Int. Cl. G02B 7/02; G02B 13/00

(52) U.S. Cl. CPC G02B 7/021; G02B 7/026; G02B 13/004

(57) ABSTRACT

Provided is a lens module, including: a lens barrel having a receiving space, a set of lenses received in the receiving space and a press-ring for fixing the set of lenses inside the lens barrel from an object side. The set of lenses includes a first lens in contact with the press-ring. The first lens includes a first optical portion for imaging and a first fixing portion surrounding the first optical portion. The lens module further includes a positioning structure, which is configured to fix the first lens to the press-ring and includes a positioning part arranged on one of the first fixing portion and the press-ring, and a holding part arranged on the other one of the first fixing portion and the press-ring; the holding part holds the positioning part.

### TECHNICAL FIELD

The present disclosure relates to the technical field of optical imaging technologies, and in particular, to a lens module.

### BACKGROUND

With development of technologies, electronic devices are becoming more and more intelligent. In addition to digital cameras, portable electronic devices such as tablets and cellphones are also equipped with a lens module having a camera function to meet the user's requirements for instant photographing. As the technology progresses, the user's requirements on imaging quality of the lens module are becoming higher and higher. The lens module known in the related art usually includes two parts, i.e., a lens barrel and a set of lenses received in the lens barrel and fixed by a press-ring disposed at an image side thereof.

The inventors have found that the imaging quality of the overall lens module is directly affected by the stability and reliability of fixation of the set of lenses. However, in the lens module in the related art, the set of lenses is generally pressed against the press-ring to be fixed, with such fixing manner, the set of lenses and the press-ring are likely to move with respect to each other, resulting in a poor stability and reliability of fixation between the lens and the press-ring.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a structural schematic cross-sectional view of a lens module according to a first embodiment of the present disclosure; and

FIG. 2 is an enlarged view of a portion A of FIG. 1.

### DESCRIPTION OF EMBODIMENTS

The present disclosure will be further illustrated with reference to the accompanying drawings and the embodiments.

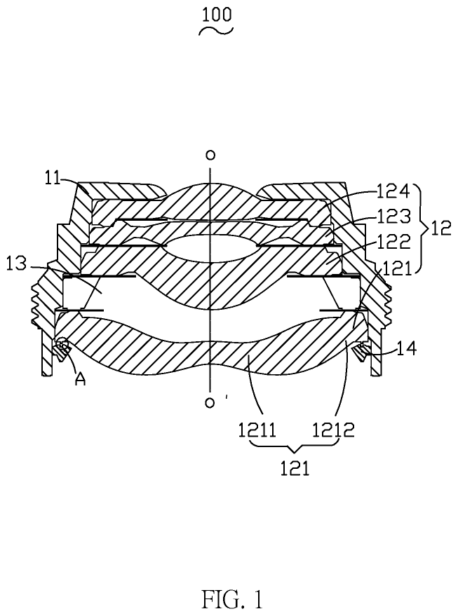

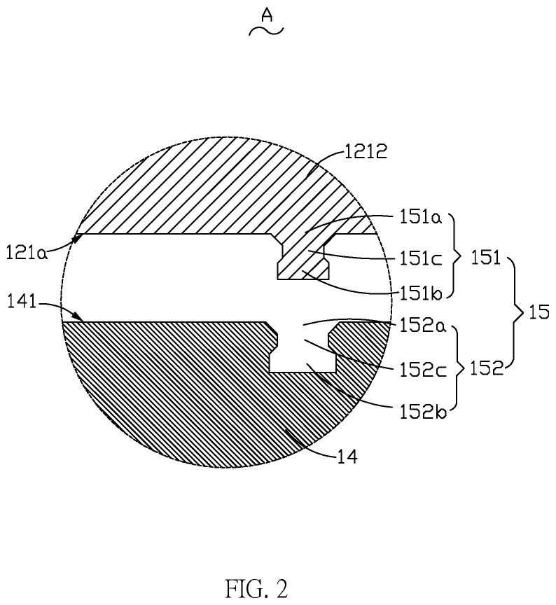

A first embodiment of the present disclosure provides a lens module 100. As shown in FIG. 1 and FIG. 2, the lens module 100 includes a lens barrel 11 and a set of lenses 12. The lens barrel 11 has a receiving space 13, and the set of lenses 12 is received in the receiving space 13. The set of lenses 12 includes a first lens 121. It should be understood that the set of lenses 12 may also include other lenses, such as a lens 122, a lens 123, and a lens 124 as shown in FIG. 1. A press-ring 14 is arranged at an image side of the first lens 121, and the press-ring 14 is disposed adjacent to the first lens 121. The first lens 121 includes a first optical portion 1211 for imaging and a first fixing portion 1212 surrounding the first optical portion 1211. The lens module 100 further includes a positioning structure 15 configured to fix the first lens 121 to the press-ring 14. The positioning structure 15 includes a positioning part 151 and a holding part 152 configured to fixedly hold the positioning part 151. The positioning part 151 is arranged on one of the first fixing portion 1212 and the press-ring 14, and the holding part 152 is arranged on the other one of the first fixing portion 1212 and the press-ring 14.

Compared with the related art, in the first embodiment of the present disclosure, the lens module 100 is provided with the positioning structure 15, in which the positioning part 151 is fixedly held by the holding part 152. Since the positioning part 151 and the holding part 152 are respectively arranged on the first fixing portion 1212 and the press-ring 14, the holding part 152 fixes the first lens 121 to the press-ring 14 while holding the positioning part 151. Due to a holding effect of the holding part 152 on the positioning part 151, both stability and reliability between the first lens 121 and the press-ring 14 are improved.

In this embodiment, the first fixing portion 1212 includes an image-side surface 121a close to an image side, and the press-ring 14 includes an object-side surface 141 disposed opposite to the image-side surface 121a. The positioning part 151 is arranged on one of the image-side surface 121a and the object-side surface 141, and the holding part 152 is arranged on the other one of the image-side surface 121a and the object-side surface 141.

Further, in this embodiment, the positioning part 151 is a protrusion, and the holding part 152 is a groove configured to match the protrusion. The so-called match herein means that the protrusion and the groove have a same shape and a same size, and the protrusion can be fitted in and stably locked in the groove, so that the holding part 152 and the positioning part 151 are relatively fixed. By means of simple structures such as the protrusion and the groove, the holding part 152 can fixedly hold the positioning part 151, and these structures are relatively simple and thus can be easily manufactured.

Furthermore, in this embodiment, the positioning part 151 (i.e., the protrusion) is arranged on the first fixing portion 1212. The positioning part 151 includes a connecting portion 151a connected to the first fixing portion 1212, a lock-in portion 151b located at an end of the connecting portion 151a facing away from the first fixing portion 1212, and a middle portion 151c connecting the lock-in portion 151b with the connecting portion 151a. A width of the lock-in portion 151b in a direction perpendicular to an optical axis OO′ of the lens module 100 is greater than a width of the middle portion 151c in the direction perpendicular to the optical axis OO′ of the lens module 100.

In addition, in this embodiment, the positioning part 151 is arranged on the first fixing portion 1212, and the holding part 152 is arranged in the press-ring 14. The holding part 152 (i.e., the groove) includes a groove opening portion 152a close to a surface of the press-ring 14, a groove bottom portion 152b disposed at an end of the surface portion 152a facing away from the surface of the press-ring 14, and a groove middle portion 152c connecting the groove opening portion 152a with the groove bottom portion 152b. The lock-in portion 151b is received in the groove bottom portion 152b, the connecting portion 151a is received in the groove opening portion 152a, and the middle portion 151c is received in the groove middle portion 152c. In the direction perpendicular to the optical axis OO′, the groove bottom portion 152b and the lock-in portion 151b each have a greater width than the groove middle portion 152c. The lock-in portion 151b is received in the groove bottom portion 152b, the middle portion 151c is received in the groove middle portion 152c, and the groove bottom portion 152b and the lock-in portion 151b each have the greater width than the groove middle portion 152c, so that the holding part 152 can fixedly hold the positioning part 151 also in a direction of the optical axis OO′, thereby preventing the first lens 121 and the press-ring 14 from relatively moving in the direction of the optical axis OO′. In this way, the stability and reliability between the first lens 121 and the press-ring 14 can be further improved.

It should be understood that the present embodiment merely illustrates an exemplary position arrangement manner of the positioning part 151 and the holding part 152, in which the positioning part 151 is arranged on the first fixing portion 1212 and the holding part 152 is arranged in the press-ring 14. In other embodiments of the present disclosure, it is also possible that the holding part 152 is arranged in the first fixing portion 1212 and the positioning part 151 is arranged on the press-ring 14, and the same technical effect can still be achieved without changing the specific structure of the holding part 152 and the positioning part 151. In the actual production process, the position arrangement manner of the positioning part 151 and the holding part 152 can be selected according to actual needs.

It should be noted that in the actual production process, the absolute parallel or perpendicular structure is impossible due to the inevitable existence of errors. Therefore, the definition terms such as “parallel” or “perpendicular” mentioned in the embodiments also indicate approximately parallel or approximately perpendicular as long as achieving the technical effect of the present disclosure.

It should be understood by those skilled in the art that the above embodiments are merely some specific embodiments of the present disclosure, and various changes in form and details may be made without departing from the scope of the present disclosure.

What is claimed is:

1. A lens module, comprising:
a lens barrel having a receiving space;
a set of lenses received in the receiving space;
a press-ring received in the receiving space, the press-ring fixing the set of lenses inside the lens barrel from an object side of the set of lenses;
and a positioning structure,
wherein the set of lenses comprises a first lens adjacent to the press-ring,
the first lens comprises a first optical portion for imaging and a first fixing portion surrounding the first optical portion,
the positioning structure is configured to fix the first lens to the press-ring, and the positioning structure comprises a positioning part arranged on one of the first fixing portion and the press-ring, and a holding part arranged on the other one of the first fixing portion and the press-ring, the holding part being configured to fixedly hold the positioning part.

2. The lens module according to claim 1, wherein the first fixing portion comprises an image-side surface close to an image side, and the press-ring comprises an object-side surface disposed opposite to the image side,
the positioning part is arranged on one of the image-side surface and the object-side surface, and the holding part is arranged on the other one of the image-side surface and the object-side surface.

3. The lens module according to claim 1, wherein the positioning part is a protrusion, and the holding part is a groove configured to fixedly match the protrusion.

4. The lens module according to claim 3, wherein the protrusion is arranged on the first fixing portion, and the protrusion comprises a connecting portion connected to the first fixing portion, a lock-in portion located at an end of the connecting portion facing away from the first fixing portion, and a middle portion connecting the connecting portion with the lock-in portion,
in a direction perpendicular to an optical axis of the lens module, the lock-in portion has a greater width than the middle portion.

5. The lens module according to claim 4, wherein the groove comprises a groove opening portion close to a surface of the press-ring, a groove bottom portion located at an end of the groove opening portion facing away from the surface of the press-ring, and a groove middle portion connecting the groove opening portion with the groove bottom portion,
the lock-in portion is received in the groove bottom portion, the connecting portion is received in the groove opening portion, and the middle portion is received in the groove middle portion,
in the direction perpendicular to the optical axis of the lens module, the groove bottom portion and the lock-in portion each have a greater width than the groove middle portion.

6. The lens module according to claim 3, wherein the protrusion is arranged on the press-ring, and the protrusion comprises a connecting portion connected to the press-ring, a lock-in portion located at an end of the connecting portion facing away from the press-ring, and a middle portion connecting the connecting portion with the lock-in portion,
in a direction perpendicular to an optical axis of the lens module, the lock-in portion has a greater width than the middle portion.

7. The lens module according to claim 6, wherein the groove comprises a groove opening portion close to a surface of the first fixing portion, a groove bottom portion located at an end of the groove opening portion facing away from the surface of the first fixing portion, and a groove middle portion connecting the groove opening portion with the groove bottom portion,
the lock-in portion is received in the groove bottom portion, the connecting portion is received in the groove opening portion, and the middle portion is received in the groove middle portion,
in the direction perpendicular to the optical axis of the lens module, the groove bottom portion and the lock-in portion each have a greater width than the groove middle portion.
